(19) United States
(12) Patent Application Publication
(10) Pub. No.: US 2022/0383365 A1
(43) Pub. Date: Dec. 1, 2022

(54) REPUTATION MANAGEMENT SYSTEM AND METHOD THEREOF

(71) Applicant: PSM Marketing, LLC, Wilsonville, OR (US)

(72) Inventors: Rod Stuckey, Peachtree City, GA (US); Tory Hornsby, Peachtree City, GA (US)

(21) Appl. No.: 17/329,573

(22) Filed: May 25, 2021

(51) Int. Cl. G06Q 30/02; G06Q 10/10; H04W 4/12

(52) U.S. Cl. CPC G06Q 30/0282; G06Q 10/10; H04W 4/12

(57) ABSTRACT

A reputation management system is disclosed comprising one or more processors configured to transmit a review request from a business computing device to a consumer computing device via a network. The review request is completed by a consumer. A reputation management platform receives the completed review and determines, via a data intake engine, if the review is in a template containing at least one image comprised of a good or service rendered by a business. A review dispatch engine to transmit the completed review to a review outlet.

### TECHNICAL FIELD

The embodiments generally relate to systems and methods for sharing, disseminating, and aggregating content containing reviews for reputation management.

### BACKGROUND

In today's market, consumers are inundated with advertisements and solicitations for various goods and services. A substantial portion of this information is biased in some manner in order to influence the potential client or consumer. However, businesses often also rely on testimonials from past customers as one of the most effective ways to begin the process of building rapport and gain the trust of consumers, especially in heavily saturated industries.

Online reputation management refers to the aggregation and control of a good or service's website search results. Many electronic markets and online communities have built-in online reputation management systems, which allow users to solicit reviews for goods and services following a sale or allow the consumer to submit a review following the purchase of the goods or services.

Many businesses solicit the review from the consumer of their goods or services. However, at times it may prove difficult to receive a review from the consumer, even if the consumer is satisfied with the goods received or services rendered. Businesses often spend a significant amount of resources in researching and testing methods for aggregating quality reviews from past clients.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a reputation management system comprising, one or more processors configured to transmit a review request from a business computing device to a consumer computing device via a network. The review request is completed by a consumer. A reputation management platform receives the completed review and determines, via a data intake engine, if the review is in a template containing at least one image comprised of a good or service rendered by a business. A review dispatch engine to transmit the completed review to a review outlet.

In one aspect, the system comprises a review generator configured to parse information received by the reputation management platform into the template.

In one aspect, the consumer submits at least one image before the service is rendered.

In one aspect, the consumer submits at least one image after the service is rendered.

In one aspect the business transmits at least one image to the consumer.

In one aspect, the business transmits the at least one image to the consumer before, during, or after the service is rendered.

A method for managing the reputation of a business is provided in the embodiments disclosed herein. The method allows for the autonomous or semi-autonomous management of reviews solicited from and provided by consumers of a business. The method comprises the steps of: transmitting, via a reputation management platform, a review request from a business computing device to a consumer computing device via a network; completing, via a consumer, the review request and submitting the review request to a reputation management platform configured to receive the completed review and process the review via a data intake engine; determining, via the data intake engine, if the review is in a template containing at least one image comprised of a good or service rendered by a business; transmitting, via a review dispatch engine, the completed review to a review outlet; and storing, via a database in operable communication with the reputation management system, the completed review.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the review request environment, according to some embodiments;

FIG. 2 illustrates a block diagram of the reputation management platform, according to some embodiments;

FIG. 3 illustrates a block diagram of the review generation system, according to some embodiments;

FIG. 4 illustrates a screenshot of the reviews and ranking interface, according to some embodiments;

FIG. 5 illustrates a screenshot of the consumer's mobile device messaging interface, according to some embodiments;

FIG. 6 illustrates a flowchart of a process for generating a review request and transmitting the review request to the consumer, according to some embodiments;

FIG. 7 illustrates a flowchart of a process for transmitting the completed review to the reputation management system, according to some embodiments; and

FIG. 8 illustrates a flowchart of a process for transmitting the completed review to a review outlet, according to some embodiments;

FIG. 9 illustrates a block diagram of the reputation management system, according to some embodiments; and

FIG. 10 illustrates a block diagram of an exemplary network architecture, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments relate to a reputation management system to solicit reviews and electronic data from a consumer following the purchase of a good or service. Following the purchase of a good or service, the consumer is contacted by the business via a mobile application or computerized software system. The business requests imagery of the good or service and a review of the good/service, provider experience, or likewise interaction between the consumer, business, and purchased good/service. The information, including imagery, is transmitted back to the business, and the information is transmitted to various social media outlets and provider webpages where a review is generated automatically. In such, the system provides a semi-automated means for optimizing SEO for the business.

As used herein, the term consumer is used to describe a user of the system who is solicited to submit a review for a service provided by the business. The consumer may receive one or more review requests, each comprising various input fields which allow for the input of information or data including text, video, audio, or image information.

As used herein, the term business is utilized to describe a user or group thereof who are soliciting the review from a consumer for goods and/or services rendered to the consumer.

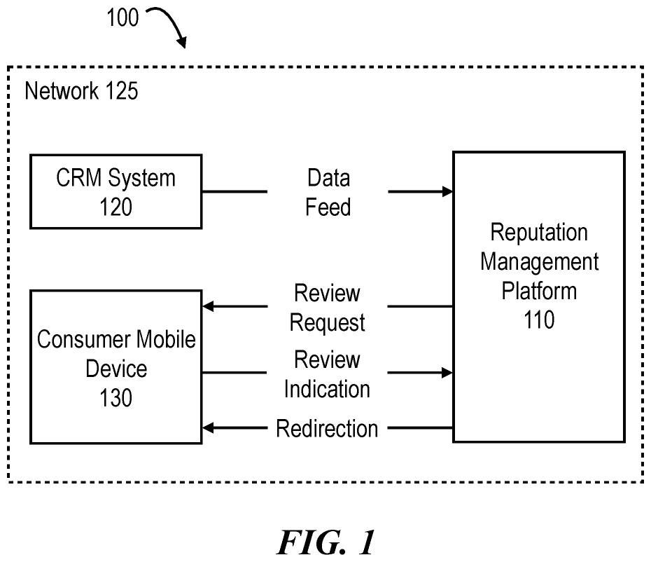

FIG. 1 illustrates a block diagram of an environment 100 in which review request are performed by a business and wherein the review is provided by the consumer. A business is a customer of a reputation management platform 110 such that the business may access the services provided by the reputation management platform 110 to manage the reputation of the business. For example, the business may be a motorcycle service and fabrication shop which utilizes the services of the reputation management platform 110 to solicit and aggregate reviews while managing their online reputation. The reputation management platform 110 is configured to aggregate reputation data and other information associated with the business and its interactions with consumers, including review websites, social networking websites, and the like, which display reviews and information related to the business. A CRM system 120 provides, via a network 125, a data feed of interactions and/or transactions that occurred involving the business which is sent to the reputation management platform 110 by the CRM system. For example, the data feed may include a product installed on a specific customers motorcycle, such as a seat installed on a motorcycle for John Smith on Feb. 1, 2020. A review request may be transmitted, via the reputation management platform, which uses the contact information for the customer to effectively transmit the review request to a consumer mobile device 130 of the customer. An indication of the review is returned to the reputation management system 110 via the consumer mobile device 130 while a redirection may be transmitted to send the customer to a review outlet as described herein.

In some embodiments, review outlets may include general purpose review sites that allow users to post reviews regarding all types of businesses. Examples of such review outlets may include Google Places, Google+, Yahoo! Local, and Citysearch. Review sites can also include travel-oriented review sites, such as TripAdvisor, that allow users to post reviews of hotels, restaurants, and attractions. Review sites can also be specific to a particular type of business, such as car dealers, healthcare professionals and/or facilities, etc. Examples of social networking sites include Twitter, Foursquare, and Facebook.

In some embodiments, customer information may include a name (e.g., first name, middle name, last name, title, etc.) of a customer of the location and contact information associated with the customer, such as an email address and/or a phone number (e.g., mobile or cellular phone number). Further the customer information may include information about the business location at which the customer interaction occurred. This can include the name, physical or mailing address, phone number, website, etc. of the business location. Customer information may also include details about the interaction or transaction with the customer that occurred at the location (e.g., visit to the repair shop, customization shop, auto dealer, or any other business type, etc. and what services or goods were provided during the visit).

The reputation management system is illustrated as a single logical element in FIG. 1. However, in various embodiments, the reputation management system is a scalable architecture and may comprise several distributed components, including components provided by one or more third parties. Further, when the reputation management system is referred to as performing a function, such as storing data or processing data, it is to be understood that a sub-component or multiple sub-components of the reputation management system may cooperate to perform that function.

In some embodiments, the reputation management platform is configured to aggregate data to assist the business in strategically managing existing reviews and obtaining additional reviews.

In one example, the consumer purchases a new seat for their motorcycle and which is installed at the motorcycle dealership (the business). Digital images are captured before and after the new seat is installed on the motorcycle which can then be automatically posted to the provider's website and social media outlets while automatically generating a review of the goods and services.

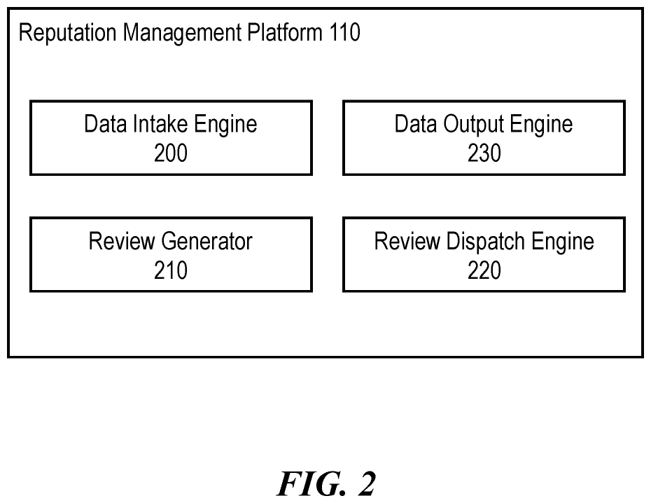

FIG. 2 illustrates exemplary elements of the reputation management platform 110 to facilitate the solicitations of review requests to consumers who have engaged the services and/or purchased goods from the business, as well as submitting the completed review to a review outlet. A data intake engine 200 permits the intake and aggregation of data received from a consumer mobile device or third-party information source and transmits the data to a database. In some embodiments, the customer provides or executes a review template. In an alternative embodiment, the reputation management platform 110 receives the data from the customer and, via a review generator 210, generates a review comprising the received customer information. A review dispatch engine 220 transmits the review to a plurality of review outlets. In some embodiments, a data output engine 230 facilitates the transmittal of information or data to the customer, the review outlet, or a third party.

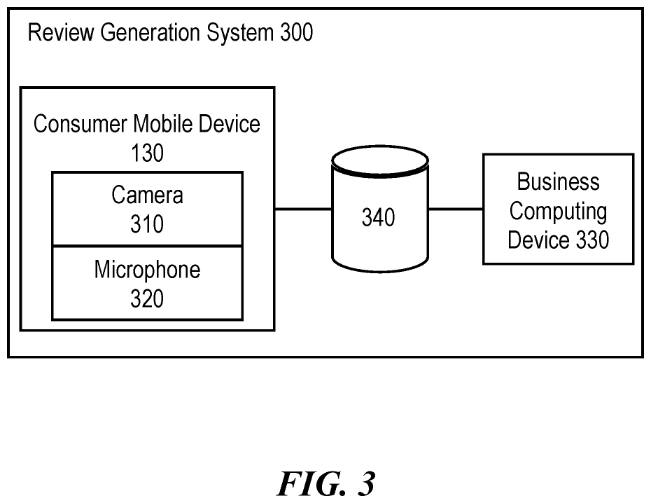

FIG. 3 illustrates a block diagram of the review generation system 300 which includes a consumer mobile device 130 in operable communication with a camera 310 and microphone 320 to permit the capture of audio and/or imagery data and provide a means to transmit the audio and or imagery data to the reputation management platform 110 and a business computing device 330. The consumer mobile device 130 may utilize a native or external database 340 to store data related to the review, including information, imagery, or similar data related to the good(s) received and/or service(s) rendered.

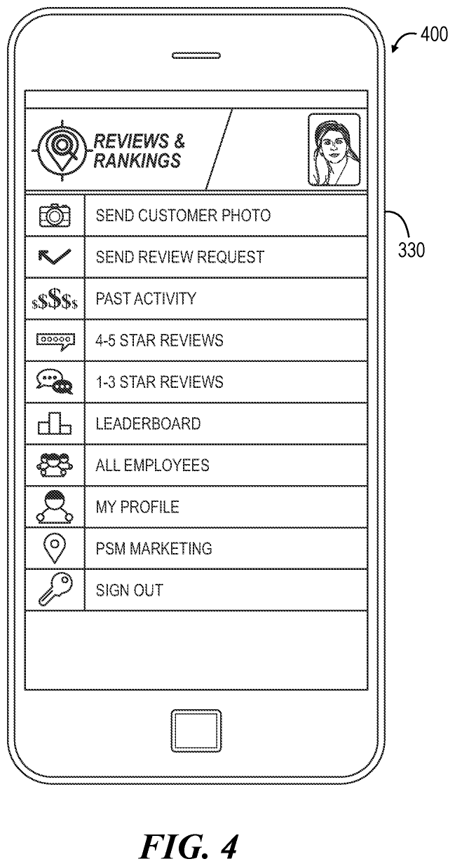

FIG. 4 illustrates an exemplary screenshot of the reviews and rankings system 400 provided on the business computing device 330. A plurality of selectable tabs are provided to permit the user to engage with various features provided by the reviews and ranking system 400 of the reputation management system described herein. As illustrated in FIG. 4, the plurality of selectable tabs may include a “Send Customer Photo” tab, a “Send Review Request” tab, a “Past Activity” tab, a “4-5 Star Reviews” tab, a “1-3 Star Reviews” tab, a “Leaderboard” tab, an “All Employees” tab, a “My Profile” tab, and a business-associated tab. In one example, the “Send Review Request” tab allows the user to generate and transmit a review request to the consumer. The “Send Customer Photo” tab permits the user to send, receive, and transmit consumer imagery data to the reputation management system.

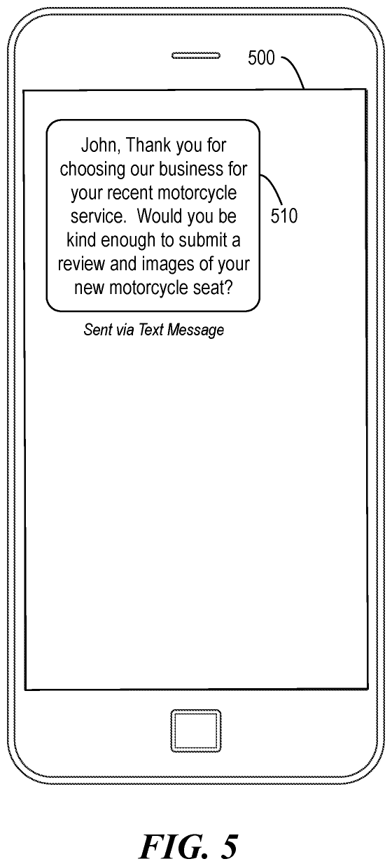

FIG. 5 illustrates a screenshot of the consumer mobile device's messaging interface 500 comprising a review request message 510 transmitted by the reputation management system. The review request message may include text, audio, and/or video information to solicit the review from the consumer.

In some embodiments, a review request message associated with a particular user-location key is sent, and the time or date at which the message was sent by the reputation management platform (e.g., using a time or date stamp) is recorded in the database. An amount of time that has elapsed since the message has been sent may be determined by accessing the user-location key (e.g., by determining the difference between the transmission time and the current time), which can be used to determine whether a follow up message should be sent. For example, for any messages for which a response has not been received within a threshold period of time (e.g., five days or any other appropriate threshold period of time), a follow up or reminder message can be transmitted by the reputation management platform.

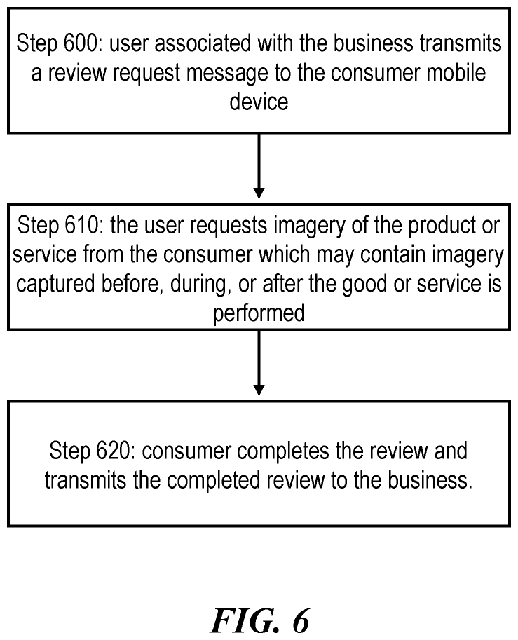

FIG. 6 illustrates a flowchart of a process for generating a review request and transmitting the review request to the consumer. In step 600, the user associated with the business transmits a review request message to the consumer mobile device. The review request message may be an SMS message or similar message which contains a request for the completion of a review. The review request may also contain imagery data captured by the business before, during, and/or following the completion of the service or at the time of purchase of one or more goods provided by the business. In step 610, the user requests imagery of the good or service from the consumer which may contain imagery captured before, during, or after the good is purchased or service is performed. In step 620, the consumer completes the review (which may include imagery data) and transmits the completed review to the business.

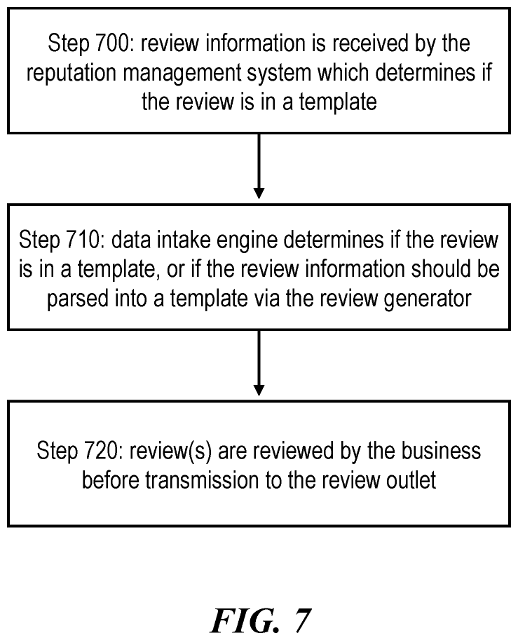

FIG. 7 illustrates a flowchart of a process for transmitting the completed review to the reputation management system. In step 700, the review information is received by the reputation management system, which determines if the review is in a template or if the review information should be parsed into a template via the review generator in step 710. The template may include imagery in addition to text provided by the consumer. In step 720, the review may be reviewed by the business before transmission to the review outlet.

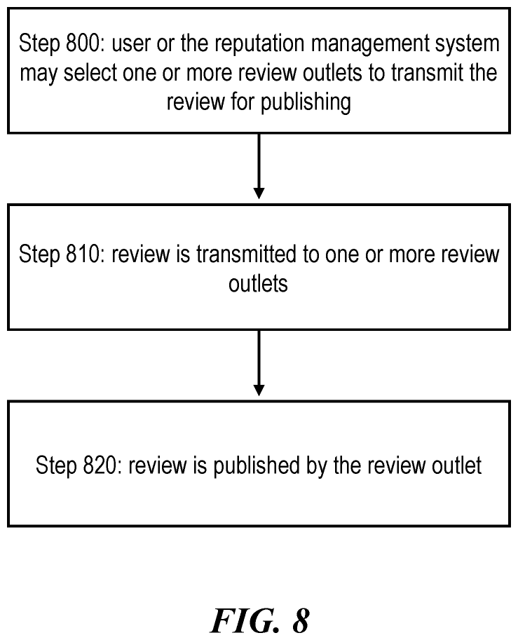

FIG. 8 illustrates a flowchart of a process for transmitting the review to the review outlet. In step 800, the user or the reputation management system may select one or more review outlets to transmit the review for publishing. Selecting the review outlet can be a decision made by the reputation management system to increase the likelihood of a favorable reputation perception on a particular website. In step 810, the review is transmitted to the one or more review outlets. In step 820, the review is published by the review outlet.

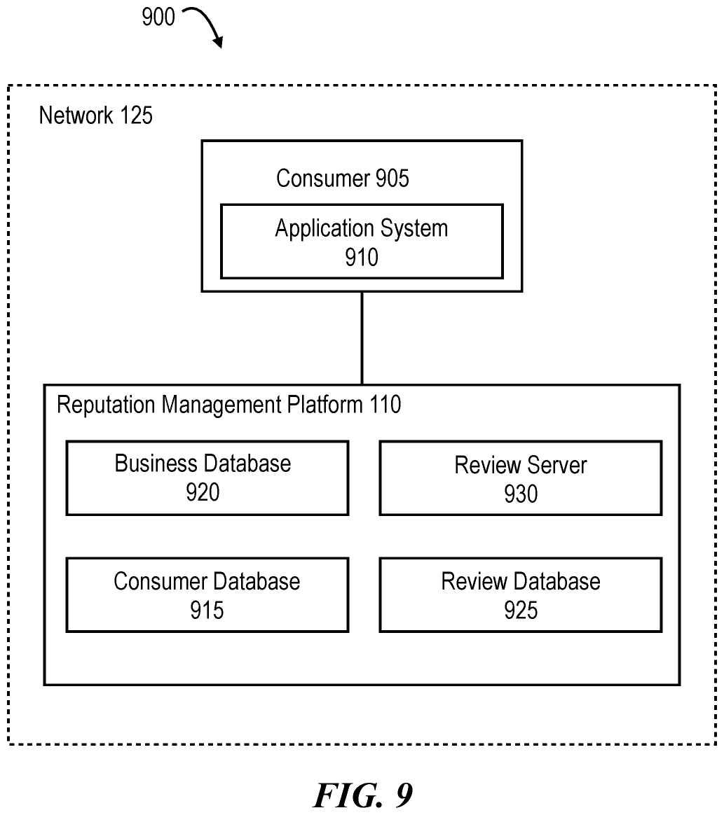

FIG. 9 illustrates a block diagram of a system 900 showing functional components of the reputation management system described hereinabove. The system 900 may include one or more consumers 905 utilizing an application system 910 to enable the consumer 905 to interact with the system 900 by providing information related to reviews for a good or service provided by a business. A network 125 connects the consumers 905 to the reputation management platform 110 including a consumer database 915, a review database 925, a business database 920, and a review server 930.

In some embodiments, consumer database 915 includes information about the various consumers (e.g., email address, screen name, and optionally an internal identifier for each consumer, where the internal identifier is used to link to all reviews authored by each consumer). Consumers may also rate the reviews of other consumers. The business database 920 may include information about various businesses offering goods and services for which reviews may be provided. The review database 925 includes reviews written about particular goods or services provided by the business(es). The review database 925 may also include reviews for merchants, restaurants, organizations (for example, charities), movies, brands, fashion, etc. The review server 930 provides access to the reviews in the review database 925, and it also provides newly received reviews to the review database 925.

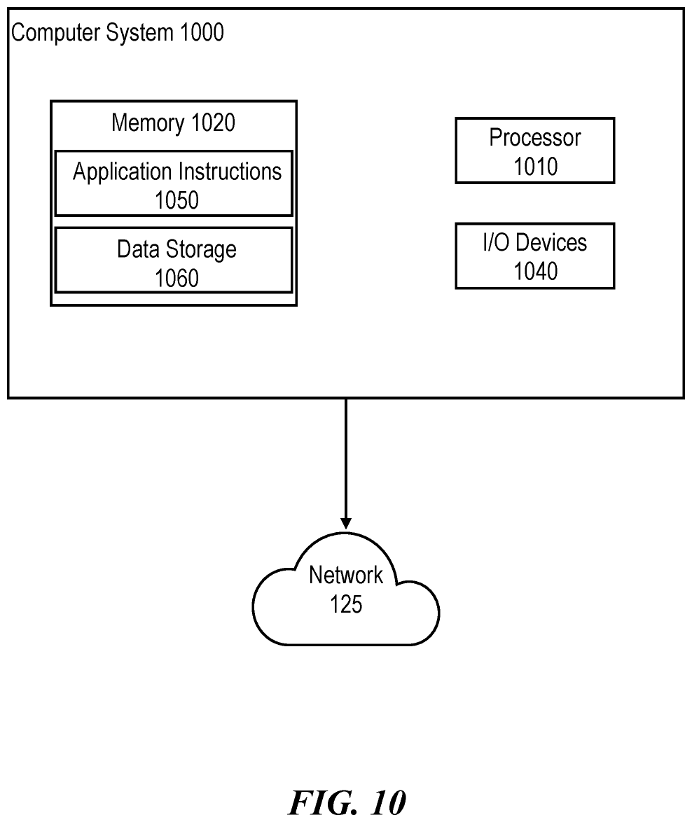

FIG. 10 illustrates a computer system 1000, which may be utilized to execute the processes described herein. The computer system 1000 is comprised of a standalone computer or mobile computing device, a mainframe computer system, a workstation, a network computer, a desktop computer, a laptop, or the like. The computer system 1000 includes one or more processors 1010 coupled to a memory 1020 via an input/output (I/O) interface. Computer system 1000 may further include a network interface to communicate with the network 125. One or more input/output (I/O) devices 1040, such as video device(s) (e.g., a camera), audio device(s), and display(s) are in operable communication with the computer system 1000. In some embodiments, similar I/O devices 1040 may be separate from computer system 1000 and may interact with one or more nodes of the computer system 1000 through a wired or wireless connection, such as over a network interface.

Processors 1010 suitable for the execution of a computer program include both general and special purpose microprocessors and any one or more processors of any digital computing device. The processor 1010 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 1000 and other devices attached to a network 125, such as other computer systems, or between nodes of the computer system 1000. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 1200 may include application instructions 1050, configured to implement certain embodiments described herein, and a database 1060, comprising various data accessible by the application instructions 1050. In one embodiment, the application instructions 1050 may include software elements corresponding to one or more of the various embodiments described herein. For example, application instructions 1050 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 1000 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 1010 such that the processor 1010 can read information from, and write information to, the storage medium. In the alternative, the storage medium may be integrated into the processor 1010. Further, in some embodiments, the processor 1010 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A reputation management system, comprising:
one or more processors configured to transmit a review request from a business computing device to a consumer computing device via a network, the review request completed by a consumer;
a reputation management platform to receive a completed review and determine, via a data intake engine, if the review is in a template containing at least one image comprised of a good or service rendered by a business; and
a review dispatch engine to transmit the completed review to a review outlet.

2. The reputation management system of claim 1, further comprising a review generator configured to parse information received by the reputation management platform into the template.

3. The reputation management system of claim 1, wherein the consumer submits at least one image before the service is rendered.

4. The reputation management system of claim 1, wherein the consumer submits at least one image after the service is rendered.

5. The reputation management system of claim 1, wherein the business transmits at least one image to the consumer.

6. The reputation management system of claim 5, wherein the business transmits the at least one image to the consumer before, during, or after the service is rendered.

7. A reputation management system, comprising:
one or more processors configured to transmit a review request from a business computing device to a consumer computing device via a network, the review request completed by a consumer and submitted to a reputation management platform configured to receive a completed review and process the review via a data intake engine configured to determine if the review is in a template containing at least one image comprised of a good or service rendered by a business;
a review dispatch engine to transmit the completed review to a review outlet;
a database in operable communication with the reputation management system to store the completed review, the reputation management system configured output data, via a data output engine, to the business.

8. The reputation management system of claim 7, wherein at least one of the one or more processors are configured to perform the steps of:
receiving the review request from the consumer;
generating the completed review comprising review information, the review information comprising the least one image; and
transmitting, via the reputation management platform, the completed review to the review outlet.

9. The reputation management system of claim 8, further comprising a review generator configured to parse information received by the reputation management platform into the template.

10. The reputation management system of claim 8, wherein the consumer submits at least one image before the service is rendered.

11. The reputation management system of claim 8, wherein the consumer submits at least one image after the service is rendered.

12. The reputation management system of claim 8, wherein the business transmits at least one image to the consumer.

13. The reputation management system of claim 12, wherein the business transmits the at least one image to the consumer before, during, or after the service is rendered.

14. The reputation management system of claim 8, wherein the review request is transmitted as an SMS message.

15. The reputation management system of claim 14, wherein the SMS message is customizable by the business.

16. The reputation management system of claim 15, wherein the reputation management platform automatically transmits a reminder message following a time threshold.

17. A method for managing the reputation of a business, the method comprising the steps of:
transmitting, via a reputation management platform, a review request from a business computing device to a consumer computing device via a network;
completing, via a consumer, the review request and submitting the review request to a reputation management platform configured to receive a completed review and process the review via a data intake engine;
determining, via the data intake engine, if the review is in a template containing at least one image comprised of a good or service rendered by a business;
transmitting, via a review dispatch engine, the completed review to a review outlet; and
storing, via a database in operable communication with the reputation management system, the completed review.

18. The method of claim 17, wherein the consumer submits at least one image before the service is rendered.

19. The method of claim 17, wherein the consumer submits at least one image after the service is rendered.

20. The method of claim 17, wherein the business transmits at least one image to the consumer.
